(19) United States
(12) Patent Application Publication
(10) Pub. No.: US 2003/0128790 A1
(43) Pub. Date: Jul. 10, 2003

(54) Method of, and receiver for, minimising carrier phase rotation due to signal adjustments and enhancements

(75) Inventor: Robert Fifield, Redhill (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/155,321

(22) Filed: May 24, 2002

(30) Foreign Application Priority Data
Jun. 20, 2001 (GB) 0115015.0

(51) Int. Cl. H04J 1/00; H04L 7/00

(52) U.S. Cl. 375/371

(57) ABSTRACT

A method of, and receiver for minimising the effects of carrier phase rotation to received Orthogonal Frequency Division Multiplex (OFDM) signals, comprises frequency down converting received signals to baseband, digitising the down converted signals (x(t)), correcting for the frequency offset in the digitised baseband signals by multiplying the digitised signals with a correction signal (c(t)) which is applied symmetrically about the symbol in order to minimise the phase rotation error. The corrected signal (x_{adj}(t)) is transformed in a FFT (26) from the time domain into the frequency domain in order to avoid inter-carrier interference and applied to a demodulator (28) for recovering the symbol values.

The present invention relates to a method of, and a receiver for, minimising carrier phase rotation due to signal adjustments and enhancements and has particular, but not exclusive, application to overcoming the effects of small frequency offsets in a received OFDM (orthogonal frequency division multiplexed) signals.

For convenience of description the present invention will be described with reference to OFDM signals but it is to be understood that the method in accordance with the present invention could be applied to other suitable modulation schemes.

U.S. Pat. No. 5,732,113 mentions that the transmission of data through a channel via OFDM signals provides several advantages over more conventional transmission techniques. These advantages include:

(a) Tolerance to multipath delay spread by having a relatively long symbol interval compared to the relatively long time of the channel impulse response.

(b) Tolerance to frequency selective fading because redundancy has been included in the OFDM signal.

(c) Efficient spectrum usage because of the close proximity of the OFDM sub-carriers.

(d) Simplified sub-channel equalization because OFDM shifts channel equalization from the time domain to the frequency domain.

(e) Good interference properties because it is possible to modify the OFDM spectrum to account for the distribution of the power of an interfering signal.

On the debit side OFDM does exhibit some disadvantages the most important being to achieve timing and frequency synchronization between a transmitter and a receiver.

If the exact timing of the beginning of each symbol within a data frame is not known the receiver will not be able to remove the cyclic prefixes and correctly isolate individual symbols before computing the FFT of their samples.

Perhaps more important and more difficult is the issue of determining and correcting for carrier frequency offset. Ideally a received carrier frequency should exactly match the transmit carrier frequency. If this condition is not met, however, the mismatch contributes to a non-zero carrier offset in the received OFDM signal. OFDM signals are very susceptible to such carrier frequency offset which causes a loss of orthoganality between the OFDM sub-carriers and results in inter-carrier interference (ICI) and a severe increase in the bit error rate (BER) of the recovered data at the receiver.

Another disadvantage is that of the synchronizing the transmitter's sample rate to the receiver's sample rate to eliminate sampling rate offset. Any mis-match between these two sampling rays results in a rotation of the 2^{m}-ary sub-symbol constellation from symbol-to-symbol in a frame.

An object of the present invention is to avoid performance degradation due to strong inter-carrier interference.

According to one aspect of the present invention there is provided a receiver comprising means for determining a phase rotation error between a transmitted signal and a received signal and means for applying a frequency offset adjustment symmetrically about a symbol in order to minimise the phase rotation error.

According to another aspect of the present invention there is provided a method of minimising carrier phase rotation in orthogonal frequency division multiplex signals, the method comprising determining a phase rotation error between a transmitted signal and a received signal and applying a frequency offset adjustment symmetrically about a symbol in order to minimise the phase rotation error.

The present invention will now be described, by way of example, with reference to the accompanying drawings, wherein:

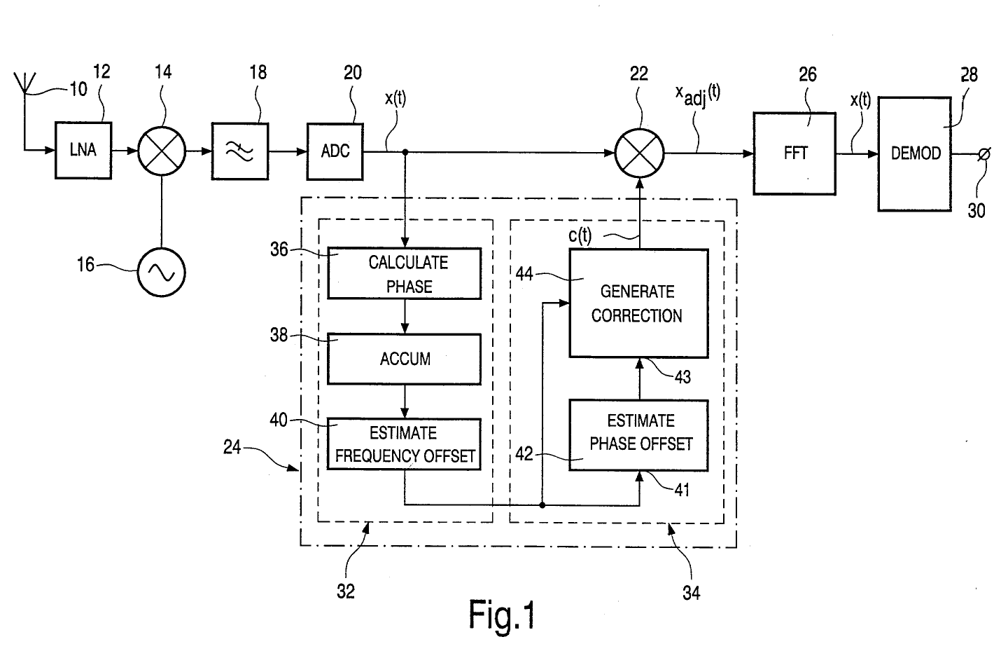

FIG. 1 is a block schematic diagram of a receiver made in accordance with the present invention,

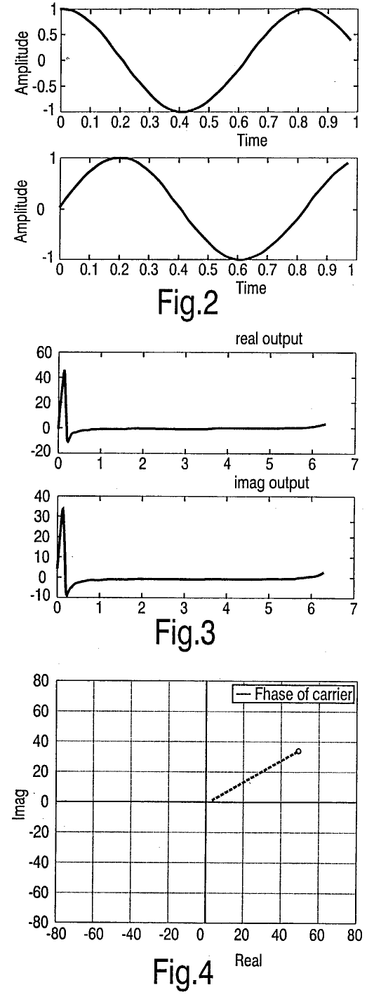

FIG. 2 are graphs of Time versus Amplitude showing the quadrature related components of a complex 1 Hz signal input with 0.2 Hz frequency offset received by a receiver made in accordance with the present invention,

FIG. 3 shows graphs of the real and imaginary outputs which have been transformed to the frequency domain,

FIG. 4 is a constellation diagram of the transformed real and imaginary outputs for a 1 Hz carrier estimated from FIG. 3,

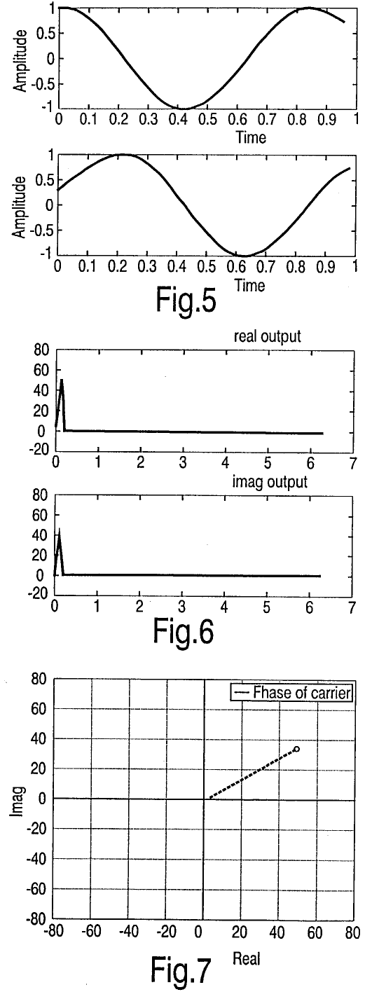

FIG. 5 are graphs of Time versus Amplitude showing the quadrature related components of a 1.2 Hz complex signal input with an estimated 0.1 Hz frequency offset which has been symmetrically derotated by −0.1 Hz,

FIG. 6 shows graphs of the real and imaginary outputs of the signals shown in FIG. 5 which have been transformed to the frequency domain,

FIG. 7 is a constellation diagram of the transformed real and imaginary outputs for a 1 Hz carrier estimated from FIG. 6,

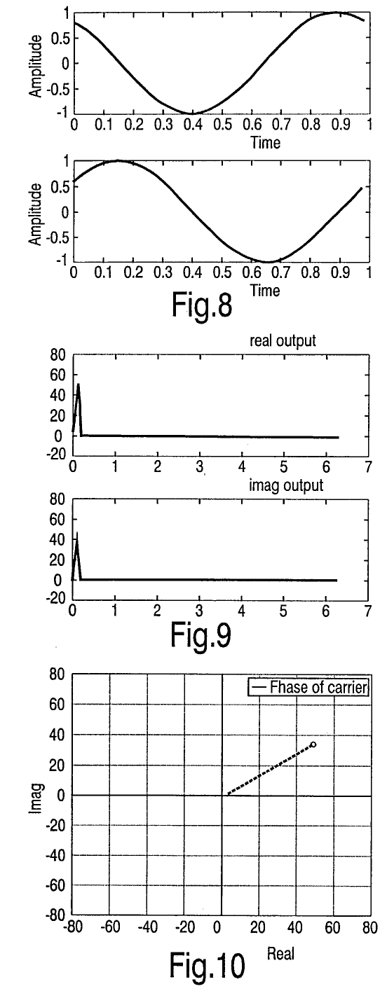

FIG. 8 are graphs of Time versus Amplitude showing the quadrature related components of a complex 1.2 Hz signal input which has been symmetrically derotated by −0.2 Hz,

FIG. 9 shows graphs of the real and imaginary outputs of the signals shown in FIG. 8 which have been transformed to the frequency domain,

FIG. 10 is a constellation diagram of the transformed real and imaginary outputs for a 1 Hz carrier estimated from FIG. 9,

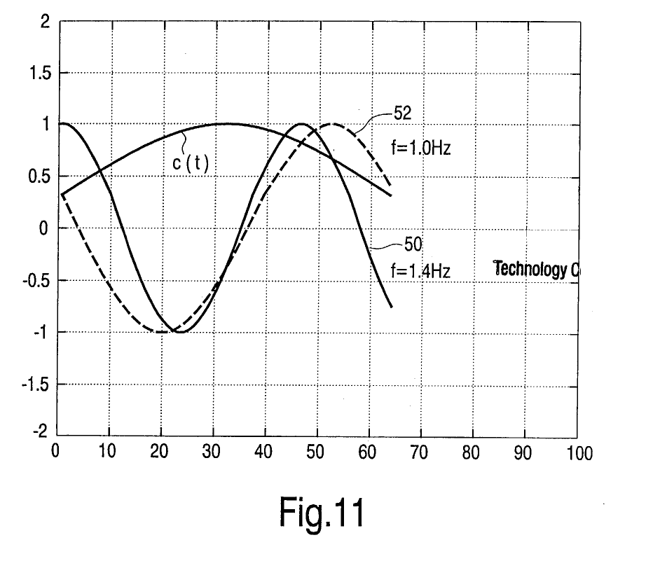

FIG. 11 illustrates the symmetrical derotation of the input signal, and

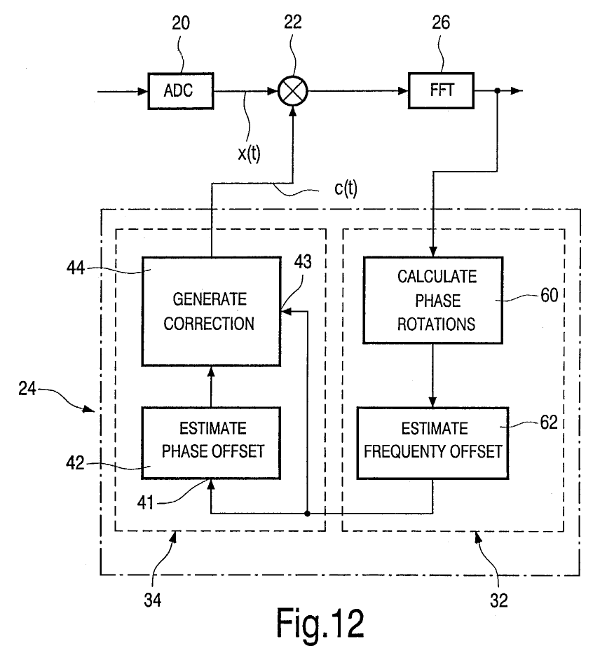

FIG. 12 is a block schematic diagram of an alternative embodiment of a measure frequency offset block.

Referring to FIG. 1, the receiver comprises an antenna 10 coupled to a RF low noise amplifier (LNA) 12. A mixer 14 has one input coupled to an output of the LNA 12 and a second input coupled to a local oscillator 16 nominally operating at the carrier frequency of an input OFDM signal. The products of mixing are applied to a low pass filter 18 which selects the baseband (or zero IF) components of the frequency down-converted signals and applies them to an analog-to-digital converter (ADC) 20 which produces a digital output x(t). The output x(t) is applied to one input of a multiplier 22 and to a block 24 for measuring frequency offset between the transmitted and received signals. An output of the block 24 comprises a correction signal c(t) which is applied to a second input of the multiplier 22. A corrected digital baseband output x_{adj}(t) of the multiplier 22 is applied to a FFT stage 26 which converts the corrected output x_{adj}(t) from being a time domain signal to a frequency domain signal X(t) consisting of OFDM carriers which is applied to a demodulator (DEMOD) 28 which recovers the symbol value and supplies it to an output 30.

The frequency offset measuring block 24 comprises two blocks 32, 34. The block 32 serves to measure the frequency offset and the block 34 serves to generate the corrective signal c(t). The block 32 comprises a stage 36 which calculates the phase of the signal x(t), an accumulator (ACCUM) 38 for storing the frequency offsets and a stage 40 which estimates the frequency offset.

The estimated frequency offset is applied to inputs 41, 43 of stages 42, 44, respectively, constituting the block 34. In the stage 42 an estimate of a symmetrical phase offset is made and applied to the stage 44 which generates a corrective sine wave (with phase offset) to correct the estimated frequency offset applied to the input 43.

In order to facilitate understanding of the method in accordance with the present invention, the effect of frequency offset correction upon the constellation of each carrier will be demonstrated by taking one single carrier in isolation.

Assume that the first carrier of a 64 carrier OFDM system is taken and all the other carriers are switched-off.

The input signal

$$x ( t ) = {\sum }_{n = 0}^{n = 63} {ⅇ}^{j 2 π f \frac{n}{64}} ( where f = 1 ) \qquad ( 1 )$$

(where f=1) (1)

If this input is given a frequency offset Δf, equation (1) becomes

$$x ( t ) = {\sum }_{n = 0}^{n = 63} {ⅇ}^{j 2 π ( f + Δ f ) \frac{n}{64}} ( where f = 1 ) \qquad ( 2 )$$

(where f=1) (2)

In order to correct the frequency offset it is necessary to multiply x(t) with a sinusoid c(t) with a frequency equal and opposite to the offset.

$$c ( t ) = {ⅇ}^{j 2 π ( - Δ {f}_{est} ) \frac{n}{64}} \qquad ( 3 )$$

However the frequency offset can only be estimated due to noise and frequency limitations.

If the estimated frequency offset is equal to the actual offset then it can be seen that when x(t) is multiplied by c(t) the frequency offset disappears:

$${x}_{adj} ( t ) = {\sum }_{n = 0}^{n = 63} {ⅇ}^{j 2 π ( f + Δ f - Δ {f}_{est} ) \frac{n}{64}} \qquad ( 4 )$$

The effect of a frequency offset upon the phase of each carrier can be determined by transforming this signal into the frequency domain. This is important for demodulation. The general expression for DFT is:

$$X ( k ) = {\sum }_{n = 0}^{N - 1} x ( n ) {ⅇ}^{- j 2 π n \frac{k}{N}} \qquad ( 5 )$$

Substituting equation (4) into equation (5) we get:

$$X ( k ) = {\sum }_{n = 0}^{n = 63} {ⅇ}^{\frac{- j 2 π n ( k )}{64}} {ⅇ}^{\frac{j 2 π n ( f + Δ f - Δ {f}_{est} )}{64}} \qquad ( 6 )$$

which simplifies to:

$$X ( k ) = {\sum }_{n = 0}^{n = 63} {ⅇ}^{\frac{j 2 π n ( f + Δ f - Δ {f}_{est} - k )}{64}} \qquad ( 7 )$$

For a 1 Hz input signal, f=1, and if the 1 Hz bin is examined then k=1, equation (7) becomes

$$X ( 1 ) = {\sum }_{n = 0}^{n = 63} {ⅇ}^{\frac{j 2 π n ( Δ f - Δ {f}_{est} )}{64}} \qquad ( 8 )$$

This equation represents the sum of 64 vectors starting from:

$$X ( 1 ) {\to }^{n = 0} {ⅇ}^{0} ≡ 1 ∠0°$$

$$X ( 1 ) {\to }^{n = 63} {ⅇ}^{\frac{j 2 π 63 ( Δ f - Δ {f}_{est} )}{64}} ≡ 1 ∠ \frac{2 π63 ( Δ f - Δ {f}_{est} )}{64}$$

The final angle is the average of the starting and finishing angle:

$$Angle ≡ \frac{π63 ( Δ f - Δ {f}_{est} )}{64}$$

From this equation it can be seen that a phase offset is induced which is proportional to the total frequency offset.

A demodulator should ideally receive an input which is not distorted by phase offset errors. One source of these errors is where a frequency offset results from phase offset errors. A phase offset error does not cause a problem as long as it is constant during the train of symbols which are being received. This assumes that the receiver correctly estimates the frequency offset at the beginning of a symbol chain and that this does not change.

However it is likely that the receiver will regularly update its frequency offset estimation during the chain of received symbols and this will change the phase offset errors introduced. The disturbance cause by these errors will effectively add more phase noise to the demodulator and cause a deterioration in BER and lead to seriously degrading the performance of the demodulator.

This problem can be mitigated by updating the frequency offset equation (3) to take into consideration the phase offset:

$$c ( t ) = {ⅇ}^{j2π ( - Δ {f}_{est} ) \frac{n}{64}} {ⅇ}^{j2π \frac{63 Δ {f}_{est}}{64 \; 2}} = {ⅇ}^{j \frac{2 πΔ {f}_{est}}{64} ( \frac{63}{2} - n )} \qquad ( 9 )$$

(Freq.comp)(Phase Comp)

It can be seen that the phase offset is updated to be roughly equal to half the total phase caused by the frequency offset.

If the offset correction is multiplied by the input signal we obtain:

$${x}_{adj} ( t ) = {\sum }_{n = 0}^{n = 63} {ⅇ}^{j \frac{2 π}{64} ( nf + nΔ f + \frac{63 Δ {f}_{est}}{2} - nΔ {f}_{est}} \qquad ( 10 )$$

By transforming equation (10) to the frequency domain it is possible to find out what effect this has upon the phase of each carrier.

Substituting our signal into the DFT equation gives:

$$X ( k ) = {\sum }_{n = 0}^{n = 63} {ⅇ}^{\frac{- j2πn ( k )}{64}} {ⅇ}^{j \frac{2 π}{64} ( nf + nΔ f + \frac{63 Δ {f}_{est}}{2} - nΔ {f}_{est} )} \qquad ( 11 )$$

$$X ( k ) = {\sum }_{n = 0}^{n = 63} {ⅇ}^{j \frac{2 π}{64} ( nf - nk + nΔ f - nΔ {f}_{est} + \frac{63 Δ {f}_{est}}{2} )} \qquad ( 12 )$$

For a 1 Hz input signal, f=1, and if the 1 Hz bin is looked at then k=1 Hz, substituting into equation (12) we get:

$$X ( 1 ) = {\sum }_{n = 0}^{n = 63} {ⅇ}^{j \frac{2 π}{64} ( nΔ f - nΔ {f}_{est} + \frac{63 Δ {f}_{est}}{2} )} \qquad ( 13 )$$

Equation (13) represents the sum of 64 vectors starting from:

$$\begin{matrix} X ( 1 ) {⟶}^{n = 0} {ⅇ}^{j63πΔ \frac{fest}{64}} \\ X ( 63 ) {⟶}^{n = 63} {ⅇ}^{j \frac{2 π63}{64} ( Δ f - Δ {f}_{est} + \frac{Δ {f}_{est}}{2} )}\end{matrix}$$

The final angle is the average of the starting and finishing angles:

$$\begin{matrix}Angle = \frac{2 π63}{2 * 64} ( Δ f - Δ {f}_{est} + \frac{Δ {f}_{est}}{2} + \frac{Δ {f}_{est}}{2} ) \\ Angle = \frac{2 π63}{2 * 64} ( Δ f )\end{matrix}$$

From an examination of this equation it can be seen that a constant phase offset is induced which is proportional to the frequency offset but this is not effected by variations in the estimated frequency offset.

The following example is used to illustrate this independence of estimated frequency offset:

An 1 Hz input signal is received with a frequency offset of 0.4 Hz.

Symbol 1

The receiver identifies a frequency offset but underestimates this as 0.1 Hz. The receiver uses the modified frequency offset correction equation which takes into account the signal phase. The resulting signal which is passed to the 64 point FFT therefore has an offset of (0.4−0.1)=0.3 Hz. This introduces a phase offset error for the first symbol of:

$$Angle ( deg ) ≡ \frac{180 * 63 ( Δ f )}{64} = 177.1 * ( 0.4 ) = 70.8 °$$

This offset is independent of the estimated adjustment frequency.

Symbol 2

The receiver recalculates the frequency offset and this time accurately determines it to be 0.4 Hz. The resulting signal which is passed to the 64 point FFT therefore has an offset of (0.4−0.4)=0 Hz. This introduces no offset error

$$Angle ( deg ) ≡ \frac{180 * 63 ( Δ f )}{64} = 177.1 * ( 0.4 ) = 70.8 °$$

The phase offset is still constant as it is only dependent upon the original frequency offset of the signal.

In implementing the method in accordance with the present invention the correction is applied symmetrically by multiplying the frequency offset estimate by the phase offset estimate, see equation (9) above, to produce a sequence of values which vary linearly from say a positive value to a negative value thereby facilitating obtaining the occurrence of a symmetrical correction. This is done by ensuring that the phase of the central sample in the time domain remains the same whilst rotating the samples either side of the central is sample to obtain the desired frequency offset correction. By doing this the average phase over the whole of the symbol remains constant and therefore the phase of each frequency carrier does not change.

In order to illustrate the benefit of applying frequency offset adjustment symmetrically about an OFDM symbol, reference is made to FIGS. 2 to 10 of the accompanying drawings.

FIGS. 2, 3 and 4 relate to a situation in which a receiver receives a complex 1.2 Hz input signal (FIG. 2). The offset frequency measuring block 24 (FIG. 1) tries to calculate the frequency offset but because of noise, it erroneously thinks that there is no offset and that the signal is a 1 Hz signal. The receiver transforms the signal to the frequency domain (FIG. 3). The 1 Hz frequency component's phase can be estimated from FIG. 3 and is plotted in FIG. 4 in the form of a constellation diagram.

FIGS. 5, 6 and 7 relate to the receiver getting the next symbol which is also offset by 0.2 Hz at 1.2 Hz. This time it estimates the frequency offset as 0.1 Hz, that is, it thinks that the received signal is 1.1 Hz. After derotating the input signal by −0.1 Hz using symmetric derotation, the input signal looks like FIG. 5. FIGS. 6 and 7 show the corresponding FFT and constellation diagrams. Although the frequency estimate was not correct, the phase of the carrier remains unchanged.

FIGS. 8, 9 and 10 relate to the receiver getting the next following symbol which is also frequency offset by 0.2 Hz at 1.2 Hz. This time it estimates the frequency offset correctly as 0.2 Hz. After derotating the input signal by −0.2 Hz using symmetric derotation, the input signal looks like FIG. 8. FIGS. 9 and 10 show the corresponding FFT and constellation diagram. It will be noticed that the phase of the carrier remains unchanged.

Referring to FIG. 11 the continuous line sine wave 50 represents an input signal having a frequency of f=1.4 Hz and the broken line sine wave 52 represents the 1.4 Hz signal which has been derotated symmetrically by −0.4 Hz to a frequency f=1.0 Hz. The derotation is effected using the frequency and phase offset correction signal c(t).

By effecting the symmetrical derotation, the phase of the carrier remains substantially unchanged. In the cases illustrated in FIGS. 2 to 4 and 5 to 7, when no derotation and less than complete derotation, respectively, occur, the phase of the carrier remains the same but is affected by noise.

By symmetrically derotating the sine wave 50 the orthogonality between OFDM sub-carriers can be maintained thereby reducing substantially the ICI and the BER in the recovered data.

FIG. 12 is a block schematic diagram of an alternative embodiment of a frequency offset measuring block 24 which could be implemented in an a FPGA (Field Programmable Gate Array), asic (application specific integrated circuit) or DSP (Digital Signal Processor). The block 24 comprises a measure frequency offset block 32 having an input coupled to an output of the FFT stage 26 and an output coupled to an input of a generate a corrective signal c(t) stage 34. The corrective signal c(t) generated by the stage 34 is applied to the multiplier 22 to derotate the digitised baseband signal x(t).

The OFDM carriers at the output of the FFT stage 26 are also applied to the stage 32 in which the average phase rotations of all the carriers is calculated in a stage 60. An output of the stage 60 is applied to a stage 62 in which the offset frequency is estimated and is supplied to an input 41 of a stage 42 for estimating the symmetrical phase offset. The estimate of the offset frequency and the estimated symmetrical phase offset are supplied to respective inputs 43 and 63 of a stage 44 for generating a corrective sine wave (with phase offset) c(t) for correcting the estimated frequency offset in the signal x(t).

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of OFDM receivers and component parts therefor and which may be used instead of or in addition to features already described herein.

1. A receiver comprising means for determining a phase rotation error between a transmitted signal and a received signal and means for applying a frequency offset adjustment symmetrically about a symbol in order to minimise the phase rotation error.

2. A receiver as claimed in claim 1, characterised by means for transforming the frequency offset adjusted symbol to the frequency domain.

3. A receiver as claimed in claim 1, characterised in that the means for determining the frequency offset adjustment comprises means for estimating a frequency offset, means for estimating a symmetrical phase offset and means for generating a corrective signal in response to the estimated frequency offset and the estimated symmetrical phase offset.

4. A receiver as claimed in claim 3, characterised by means for receiving a signal, means for producing a baseband signal from the received signal, digitising means for digitising the baseband signal, multiplying means for multiplying the digitised signal by the corrective signal to produce a corrected digital output signal and means for transforming the corrected digital output signal to the frequency domain.

5. A method of minimising carrier phase rotation in orthogonal frequency division multiplex signals, the method comprising determining a phase rotation error between a transmitted signal and a received signal and applying a frequency offset adjustment symmetrically about a symbol in order to minimise the phase rotation error.

6. A method as claimed in claim 5, characterised by transforming the frequency offset adjusted symbol to the frequency domain.

7. A method as claimed in claim 5, characterised by determining the frequency offset adjustment by for generating a corrective signal in response to the estimated frequency offset and the estimated symmetrical phase offset.

8. A method as claimed in claim 7, characterised by receiving a signal, producing a baseband signal from the received signal, digitising the baseband signal, multiplying the digitised signal by the corrective signal to produce a corrected digital output signal and transforming the corrected digital output signal to the frequency domain.
